(19) United States
(12) Patent Application Publication
(10) Pub. No.: US 2011/0183029 A1
(43) Pub. Date: Jul. 28, 2011

(54) METHOD AND ARRANGEMENT TO IMPROVE THE PRODUCTION OF A BLADE

(76) Inventor: Karsten Schibsbye, Fredericia (DK)

(21) Appl. No.: 13/014,063

(22) Filed: Jan. 26, 2011

(30) Foreign Application Priority Data
Jan. 28, 2010 (EP) EP10000880

(51) Int. Cl. B29C 45/14

(52) U.S. Cl. 425/506

(57) ABSTRACT

A method and an arrangement to improve the production of a blade, preferably to improve the production of a wind turbine blade is provided. A first container includes a resin. The first container is connected with a degas-system, thus the resin is provided to the degas-system. The degas-system is constructed and designed in a way that the amount of gas within the provided resin is reduced. Thus gas-reduced resin is produced, which is mixable with a hardener. The resin-hardener-mixture is applicable for an injection into an enclosed composite structure, which is used to produce the blade.

### CROSS REFERENCE TO RELATED APPLICATIONS

This application claims priority of European Patent Office application No. 10000880.4 EP filed Jan. 28, 2010, which is incorporated by reference herein in its entirety.

### FIELD OF INVENTION

The invention relates to a method and to an arrangement to improve the production of a blade, preferably to improve the production of a wind turbine blade.

### BACKGROUND OF INVENTION

The three-dimensional shape of a blade is built up by a number of layers for example. The layers are stacked preferably, supported by a base.

The layers may contain sheets of glass-fibres, balsa wood, air-pockets, etc. The blade is built up like a sandwich as a composite structure.

It is known to use a first mould, which supports the three-dimensional blade structure. A second mould is connected with the first mould, thus a resulting mould-system encloses the blade. Air is evacuated out of the mould system, while a combination of resin and a hardener is injected into the mould system. The resin and the hardener penetrate the composite structure of the blade. The resin cures out next, thus a main work is already done during the process to manufacture the blade.

The resin and the hardener may be provided in large containers (such as so called “batch container” or “intermediate bulk container, IBC”) if large quantities are needed. These containers are used especially, if a large wind turbine blade is produced. This kind of blade shows a typical length of 50 meters or even more.

The resin/hardener-mixture contains a large quantity of microscopic gas bubbles, while the gas may be absorbed from the air for example.

If the mixture is injected e.g. by a so called “Vacuum Assisted Resin Transfer, VART” into the mould-system the gas bubbles accumulates into the composite structure, too. Experiences have shown that the gas bubbles accumulate especially at locations where the composite is most porous. For example the bubbles accumulate in the glass fibre material at locations, where the denseness of the fibres is lowest.

Furthermore bubbles may accumulate near an inlet, where the resin/hardener-mixture is injected into the mould-system.

This leads to an extensive number of small voids in the casted blade structure, which weakens the structure of the blade.

Additionally the surface of the blade will become even porous and sensible to environmental impacts if the bubbles accumulate near the surface of the blade. Thus the life time of the blade is decreased.

The completed blade is object of a test-procedure, which is done by help of non-destructive testing-methods. The voids also influence this test negatively.

There are a number of attempts to degas the mixture of resin and hardener, but the resulting process is often time-extensive and thus expensive.

Additionally the mixture starts to harden during the degassing process and thus it is very difficult to ensure an optimized “mixing-and-injection” process.

### SUMMARY OF INVENTION

It is therefore the aim of the invention to provide an improved method and arrangement to produce a blade, while gas bubbles inside the injected mixture are reduced or even avoided.

This aim is reached by the features of the claims.

Preferred configurations are object of the dependent claims.

According to the invention resin is degassed before it is mixed with a hardener for an injection intended during a blade-production-process.

To do the blade-production-process the resin is mixed with a hardener by a machine for example.

The resin is applied from a first container, while the hardener is applied from a second container for example.

Before the mixture is done, the resin is applied to a degas-system. This degas-system is constructed and designed in a way that the amount of gas within the provided resin is reduced. The gas-reduced resin is provided to the machine to generate the needed resin-hardener-mixture.

The mixture is applied to an enclosed composite structure of the blade for example. The mixture of resin and hardener is injected into the composite structure to manufacture the blade.

The degassing of the resin may be achieved by an applied vacuum or by an applied pressure-difference as described later. They are applied in periodic time-intervals for example.

It is also possible to apply vibrations to the resin for its degassing.

Or an additive is added to the resin, which is used to reduce or even remove the gas out of the resin.

It is also possible to use a permeable material (like the well known “GORE-TEX®” material, etc.) as filter-material. For example gas bubbles within the resin are allowed to pass through this filter while the degassed resin is mixed with the hardener later during the blade-production process.

In a preferred configuration an active carbon filter is used to filter the gas removed form the resin. Thus the gas is cleaned before it is brought to the ambient air.

Various test have shown, that the amount of gas (bubbles) in the resin is bigger than the amount of gas (bubbles) in the hardener. Thus the invention uses this knowledge advantageously.

The reduction of the gas bubbles in the resin is sufficient to avoid the problems stated in the introduction part of this application.

For usually used mixtures of resin and hardener the amount of resin within the mixture is higher than the amount of hardener.

These mixtures may contain a “resin/hardener”-ratio of 3:1 for epoxy or of 100:1 for Polyester or Vinylester for example.

Thus the degassing of the resin according of the invention results in a drastically decrease of the gas-bubbles within the mixture.

This in turn decreases the amount of voids in the casted blade-structure, hereby all outlined problems are minimized or even reduced.

Only a small amount of fluid—the resin itself—needs to be degassed, thus the inventive arrangement can be applied very easy to production lines.

The degassing of the resin is quite fast as only the amount of resin needs to be processed.

According to the invention the degassing is done before the resin is mixed with the hardener. Thus time is saved. The mixture is applied to the blade structure immediately and without any further delays, thus a hardening of the mixture within the feeding-system is avoided. It is ensured, that the mixture is injected into the closed mould-system with a desired viscosity.

There is no need to perform a degassing during the injection process, thus production time is saved.

The blade-structure shows a reduced amount of voids. Thus additional work to repair the surface is reduced. The structural strength of the blade is increased.

The test results of the non-destructive-testing-procedure, applied to the blade, are improved.

### BRIEF DESCRIPTION OF THE DRAWINGS

The invention is described by help of some figures. The figures show preferred configurations and do not limit the scope of the invention.

FIG. 1 shows a preferred first configuration of the invention,

FIG. 2 shows a preferred second configuration of the invention,

FIG. 3 shows a preferred third configuration of the invention, and

FIG. 4 shows a preferred fourth configuration of the invention.

### DETAILED DESCRIPTION OF INVENTION

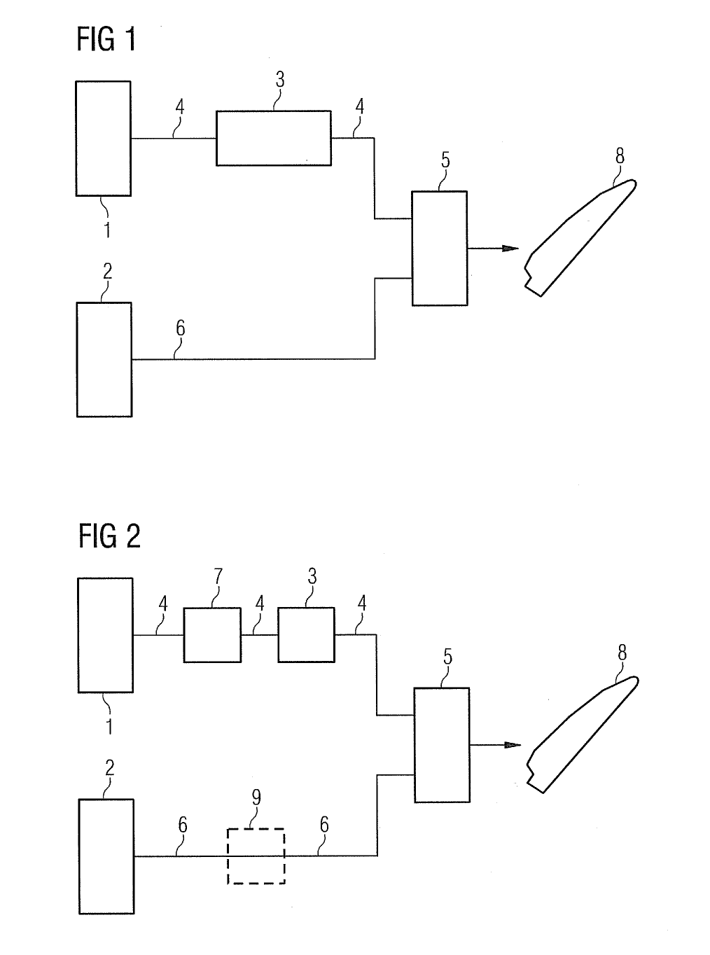

FIG. 1 shows a preferred first configuration of the invention.

The arrangement contains a first container 1 and a second container 2. The first container 1 comprises the resin, while the second container 2 comprises the hardener.

The resin container 1 is connected with a degas-system 3 by help of a resin-hose 4. Thus resin is provided from the first container 1 to the degas-system 3.

The degas-system 3 is constructed and designed in a way, that the provided resin is degassed.

For this purpose the degas-system 3 may contain an arrangement, which applies a pressure-variation or a technical vacuum to the resin, which contains the gas bubbles.

Due to the pressure-variation the enclosed (more smaller) gas bubbles will band with adjacent gas bubbles, thus bigger-sized bubbles are built. These bubbles ascend to the resin-surface and can be extracted very easily.

The degas-system 3 is connected with a machine 5 via another resin-hoe, thus degassed resin is provided to the machine 5.

The second container 2 is also connected with this machine 5 by a hardener hose 6, thus hardener is provided to the machine 5.

The machine 5 is constructed and designed in a way, that the resin is mixed with the hardener in a predetermined ratio. Next the mixture is provided to the enclosed composite structure 8 of the blade.

FIG. 2 shows a preferred second configuration of the invention, with reference to FIG. 1.

One or more heaters 7 are located between the first container 1 and the degas-system 3. The heater 7 is connected with them by a resin hose 4.

The heater 7 is constructed and designed in a way that the resin is warmed before it is applied to the degas-system 3.

The heater 7 changes the viscosity of the resin, which is an advantage for the applied degas process of the resin.

Preferably the temperature of the heated resin is approximately 35° C.

Preferably one or more heaters 9 are located between the second container 2 and the mixing-machine 5. The heater 9 is connected with them by a hardener-hose 6.

The heater 9 is constructed and designed in a way that the hardener is warmed before it is applied to the machine 5.

The heater 9 changes the viscosity of the hardener, which is an advantage for mixture of the resin and the hardener within the machine 5.

Preferably the temperature of the heated hardener is approximately 35° C.

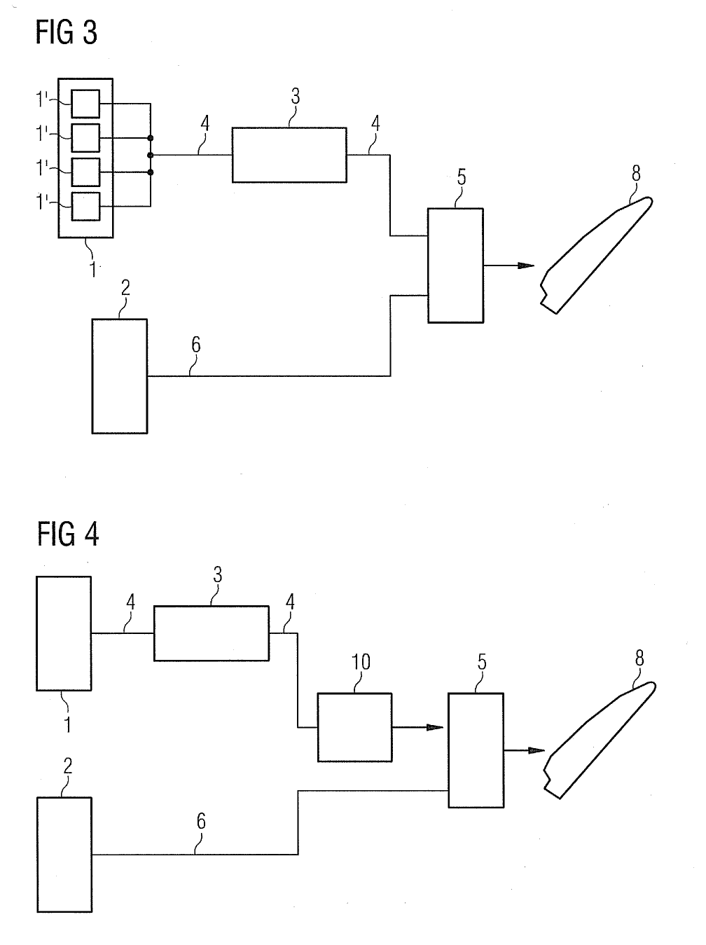

FIG. 3 shows a preferred third configuration of the invention, with reference to FIG. 1.

The first container 1 contains a number of sub-containers 1′, which are connected. This allows the change of one of the sub-containers 1′, as soon it is emptied.

This arrangement is preferably used for large wind-turbine-blades.

Even the second container 2 may contain a number of sub-containers for the hardener—not shown here in detail.

Referring to one of the figures FIG. 1 up to FIG. 3 the level of gas-bubbles within the resin and/or the hardener and/or the mixture is measured by a dedicated measurement-equipment.

This allows the control of the flow through the degas-system 3 in dependency of the measured level(s). Thus a closed-loop configuration is be realised for an optimized production-procedure.

FIG. 4 shows a preferred configuration of the invention, with reference to FIG. 1.

Experiments have shown that after the degassing the resin can stay in a container 10, used as a reservoir, for a certain time period. It is possible to keep the degassed resin at stock for a week or even longer.

Therefore it is possible to degas the resin in due time before the blade-production process.

This allows the transportation of the degassed resin to another and remote location, where the blade production is intended to be done.

1.-14. (canceled)

15. An arrangement to improve the production of a blade, comprising:
a first container including a resin; and
a degas system,
wherein the first container is connected with the degas-system whereby the resin is provided from the first container to the degas-system,
wherein the degas-system is constructed and designed so that an amount of gas within the provided resin is reduced, and
wherein the gas-reduced resin is mixable with a hardener, whereby a resin-hardener-mixture is applicable for an injection into an enclosed composite structure which is used to produce the blade.

16. The arrangement according to claim 15, further comprising:
a second container which includes the hardener; and
a machine which is connected with the degas-system whereby the gas-reduced resin is provided to the machine,
wherein the machine is constructed and designed so that a mixture of gas-reduced resin and hardener, applied from the second container, is generated by the machine, and
wherein the machine is connected with the enclosed composite structure of the blade, whereby the mixture of gas-reduced resin and hardener is injected into the enclosed composite structure.

17. The arrangement according to claim 15,
wherein the degas-system comprises a first means to apply a pressure-variation or a technical vacuum to the resin, and/or
wherein the degas-system comprises a second means to apply vibrations to the resin, and/or
wherein the degas-system comprises a third means to apply an additive to the resin, and/or
wherein the degas-system comprises a permeable filter-material, which is constructed so that gas within the resin is allowed to pass through the filter in order to reduce the amount of gas within the resin.

18. The arrangement according to claim 17, wherein the degas-system comprises or is connected with an active carbon filter in order to clean the gas before the gas is brought to ambient air.

19. The arrangement according to claim 15, wherein a heater is located between the first container and the degas-system, whereby the resin is warmed up prior to being applied to the degas-system.

20. The arrangement according to claim 19, wherein the resin is heated up to approximately 35° C.

21. The arrangement according to claim 16, wherein a heater is located between the second container and the machine, whereby the hardener is warmed up before being applied to the machine.

22. The arrangement according to claim 21, wherein the hardener is heated up to approximately 35° C.

23. The arrangement according to claim 16, wherein the first container and/or the second container comprises a plurality of sub-containers, which are connected to each other.

24. The arrangement according to claim 16, wherein a measurement-equipment is constructed and arranged in a way that the level of gas within the resin and/or within the hardener and/or within the mixture is measured, while a flow through the degas-system is controlled in dependency of the measured level.

25. The arrangement according to claim 16, wherein the mixture is mixed using a predetermined ratio.

26. A method to manufacture a blade, comprising:
reducing an amount of gas within a resin before the resin is used for a blade-production-process.

27. The method as claimed in claim 26, wherein the gas-reduced resin is mixed with a hardener for an injection into an enclosed composite structure used to manufacture the blade.

28. The method according to claim 26,
wherein a pressure-variation or a technical vacuum is applied to the resin, and/or
wherein vibrations are applied to the resin, and/or
wherein an additive is applied to the resin, and/or
wherein the resin is filtered by a permeable filter-material, which is constructed in a way, that gas within the resin is allowed to pass through the filter to reduce an amount of gas within the resin.

29. The method according to claim 26, wherein the resin is warmed up before an amount of gas within the resin is reduced.

30. The method according to claim 29, wherein the resin is warmed up to approximately 35° C.

31. The method according to claim 27, wherein the hardener is warmed up prior to being mixed with the gas-reduced resin.

32. The method according to claim 31, wherein the hardener is warmed up to approximately 35° C.

33. The method according to claim 27, wherein a level of gas within the resin and/or within the hardener and/or within the mixture is measured whereby the gas-reduction is controlled in dependency of the measured level.

34. The method according to claim 33, wherein the mixture is mixed using a predetermined ratio.
